(19) United States
(12) Patent Application Publication
(10) Pub. No.: US 2013/0022388 A1
(43) Pub. Date: Jan. 24, 2013

(54) LOWER BALL JOINT ASSEMBLY

(71) Applicant: Sage T. Carli, Orange, CA (US)

(72) Inventor: Sage T. Carli, Orange, CA (US)

(21) Appl. No.: 13/189,468

(22) Filed: Jul. 22, 2011

(51) Int. Cl. F16C 11/06; B23P 11/00

(52) U.S. Cl. 403/39; 403/122; 29/428

(57) ABSTRACT

Embodiments of the invention are directed to a lower ball joint assembly for connecting a lower control arm to a steering knuckle of a vehicle. In one embodiment, the lower ball joint assembly comprises a plurality of components including a ball-head tapered ball joint pin (or stud), a ball joint housing and a securing ring configured to assemble together into a lower ball joint assembly. In an assembled configuration, a proximal, or ball-head, of the ball-head tapered ball joint pin may be housed within the ball joint housing. The securing ring may reversibly couple with a distal end of the ball joint assembly by a plurality of fasteners to complete the assembly. The ball joint assembly may have a hardness characteristic of between forty (40) and one-hundred (100) Rockwell.

### FIELD OF INVENTION

Automobile parts.

### BACKGROUND OF INVENTION

In an automobile, the steering assemblage allows the driver to control the vehicle. Typically, the steering wheel is connected to the suspension and wheels via the steering knuckles. The steering knuckles, in turn, connect the steering wheel to the rest of the automobile which allows the driver to direct the vehicle. Two control arms link the chassis and the front suspension, while leaf springs connect the chassis to the rear suspension. Tie rod ends connect to the steering knuckles, which directly control the wheels.

The control arms are connected to the frame with pivoting mounts. Ball joints connect the front axle to the steering knuckle. Ball joints allow the steering knuckle to pivot during steering. As the driver turns the wheel, motion is transferred down the steering shaft to the steering gear.

Factory-installed ball joints in automobiles typically require lubricant and generally need to be replaced every two (2) years with “normal” vehicle use. Over time, ball joint replacement is often required due to poor lubrication (infrequent or insufficient) or excessive play from the soft bronze bushing contained in the assembly. Additionally, severe impacts may cause increased compressive stress on conventional ball joints thereby compromising their integrity. As a result, under extreme uses, such as off-road driving and driving at higher speeds, a ball joint pin may become loose inside the cup creating excessive play in the steering.

Consequently, a ball joint assembly which alleviates the problems inherent in conventional ball joint assembly as described previously is needed.

### SUMMARY OF INVENTION

One feature is directed to a lower ball joint assembly for a vehicle. The lower ball joint assembly includes a ball-head tapered ball joint pin having a proximal portion, a medial portion and a distal portion, the proximal portion comprising a ball-head having a plurality of grooves radially extending downwardly, from a top portion of the ball-head toward the medial portion of the ball joint pin, at least partially around a circumference of the ball-head; a ball joint housing having a recess therein adapted to receive at least a portion of the ball-head of the ball-head tapered ball joint pin; and a securing ring having a securing ring opening in the center thereof, the securing ring adapted to reversibly couple to a distal end of the ball joint housing.

The recess of the ball joint housing comprises a hemispherical top portion, a generally circular base portion and a channel located there between approximating a dome configuration, wherein the channel collects lubricant dispersed via the plurality of grooves creating a reservoir of the lubricant inside the ball joint housing.

According to one feature, the securing ring, from a proximal end to the distal end, comprises a securing ring upper flange, a securing ring medial portion and securing ring lower flange wherein the securing ring upper flange has a tapered inner sidewall and has at least one inner diameter (i) less than an inner diameter of the securing ring medial portion and (ii) greater than an inner diameter of the securing ring lower flange.

According to one feature, the ball joint housing, from a proximal end to the distal end, comprises a ball joint housing upper flange, a first portion, a second portion and a ball joint housing lower flange.

According to one feature, when in an assembled configuration, (i) the ball-head rests within the recess of the ball joint housing and (ii) a plurality of fasteners reversibly couple the securing ring to the lower flange of the ball joint housing thereby securing the ball-head within the recess of the ball joint housing.

According to one feature the lower ball joint assembly is comprised of high-strength low-alloy steel and has a hardness greater than 56 Rockwell.

According to one feature, a process for manufacturing a lower ball joint assembly is provided. The process includes forming a ball-head tapered ball joint pin from high-strength low-alloy steel, the ball-head tapered ball joint pin having a proximal portion, a medial portion and a distal portion, the proximal portion comprising a ball-head having a plurality of grooves radially extending downwardly, from a top portion of the ball-head toward the medial portion of the ball joint pin, at least partially around a circumference of the ball-head; forming a ball joint housing from high-strength low-alloy steel, the ball joint housing having a recess therein adapted to receive at least a portion of the ball-head of the ball-head tapered ball joint pin; and forming a securing ring from high-strength low-alloy steel, the securing ring having a securing ring opening in the center thereof, the securing ring adapted to reversibly couple to a distal end of the ball joint housing wherein the joint assembly has a hardness greater than 56 Rockwell.

The process further includes applying a non-liquid lubricant to the assembly; applying a heat treatment to the assembly to achieve the hardness greater than 56 Rockwell; inserting the ball-head into the ball joint housing such that ball-head is seated within the recess of the ball joint housing; and coupling the securing ring to the ball joint housing thereby securing the ball-head within the recess of the ball joint housing.

### BRIEF DESCRIPTION OF DRAWINGS

FIG. 1 illustrates an exploded view of a lower ball joint assembly in an unassembled configuration according to an embodiment of the invention.

FIG. 2 illustrates a side view of the lower ball joint assembly of FIG. 1 in an assembled configuration.

FIG. 3 illustrates a side cross-sectional view of a ball joint housing of a lower ball joint assembly according to an embodiment of the invention.

FIG. 4 illustrates a side view of a ball-head tapered ball joint pin of a lower ball joint assembly according to an embodiment of the invention.

FIGS. 5A-5B illustrate a side cross-sectional view and a top view of a securing ring of a lower ball joint assembly according to an embodiment of the invention.

FIG. 6 illustrates a side cross-sectional view of a ball joint housing of a lower ball joint assembly according to an embodiment of the invention.

FIG. 7 illustrates a side view of a ball-head tapered ball joint pin of a lower ball joint assembly according to an embodiment of the invention.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to a lower ball joint assembly for connecting a lower control arm to a steering knuckle of a vehicle. In one embodiment, the lower ball joint assembly comprises a plurality of components including a ball-head tapered ball joint pin (or stud), a ball joint housing and a securing ring configured to assemble together into a lower ball joint assembly. In an assembled configuration, a proximal, or ball-head, of the ball-head tapered ball joint pin may be housed within the ball joint housing. The securing ring may reversibly couple with a distal end of the ball joint assembly by a plurality of fasteners to complete the assembly. In one embodiment, the ball joint assembly may have a hardness characteristic of between forty (40) and one-hundred (100) Rockwell.

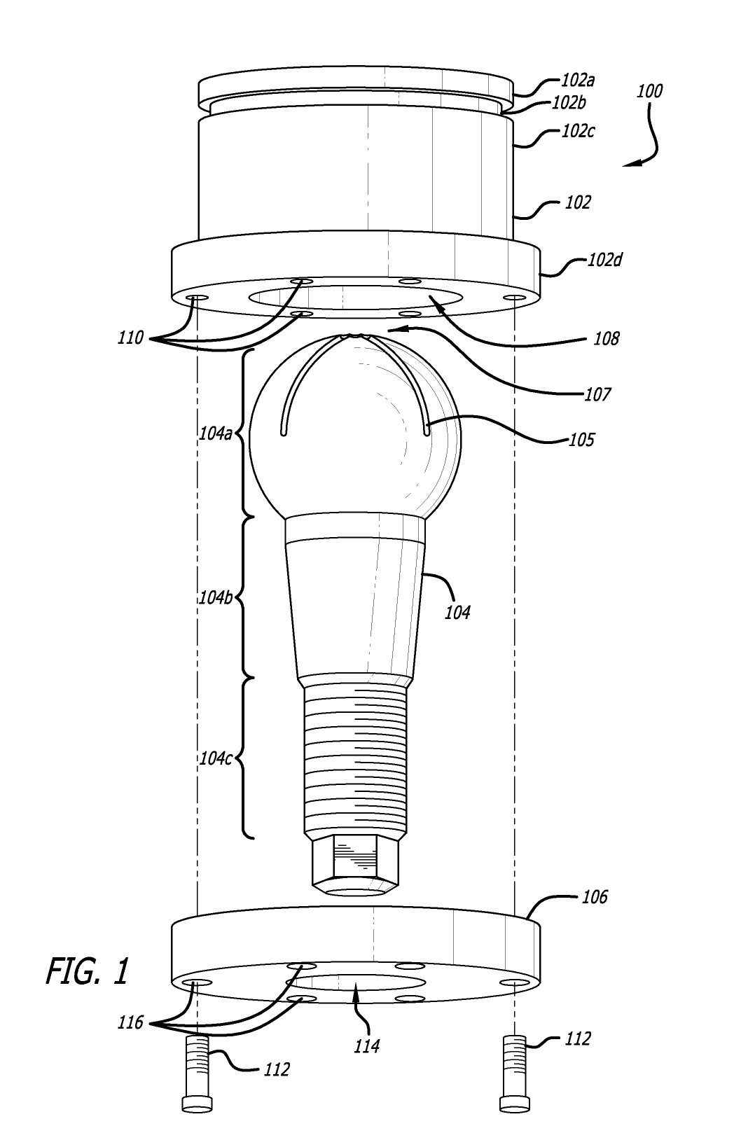

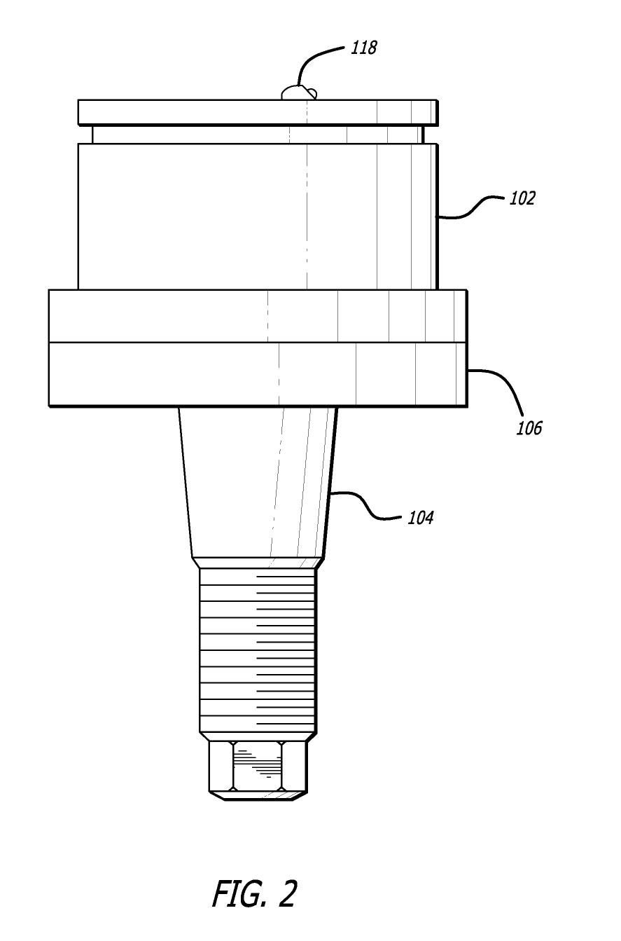

FIG. 1 illustrates an exploded view of a lower ball joint assembly in an unassembled configuration according to an embodiment of the invention. As shown, the lower ball joint assembly 100 includes a ball joint housing 102, a ball-head tapered ball joint pin 104 and a securing ring 106 configured to assemble together as a single unit (see FIG. 2). In one embodiment, the ball joint housing 102 approximates a cylindrical housing. More specifically, from a proximal end to the distal end, the ball joint housing includes a ball joint housing upper flange 102a, a first portion 102b, a second portion 102c and a ball joint housing lower flange 102d.

Ball joint housing 102 may also include a recess 108 capable of receiving a ball-head of the ball-head tapered ball joint pin 104 (explained in more detail below). From the distal end to the proximal end of ball joint housing 102, recess 108 extends from a bottom surface of the ball joint housing lower flange 102d and terminates just below a plane defining the upper most edge of the second portion 102c (see FIG. 3). Recess 108 may comprise a hemispherical top portion, a generally circular base portion and a channel located there between approximating a dome configuration (see FIG. 3). That is, recess 108 may be configured to receive a spherical or spherical-like component (e.g., a ball-head). In one embodiment, ball joint housing 102 may include a plurality of openings 110 symmetrically spaced about the ball joint housing lower flange 102d. The plurality of openings may extend from a bottom surface of the joint housing lower flange 102d to a plane defining the upper most edge of the lower flange 102d and may be configured to threadedly receive a plurality of fasteners 112 (explained in more detail below). In one embodiment, the proximal end of ball joint housing 102 (i.e., top) may include a fitting recess capable of housing a connector (see FIG. 3).

Continuing to refer to FIG. 1, from a proximal end to the distal end, ball-head tapered ball joint pin 104 includes a proximal portion 104a, a medial portion 104b, and a distal portion 104c. The proximal portion 104a may generally comprise a ball-head; the medial portion 104b, integrally connected between the proximal portion 104a and the distal portion 104c, may generally comprise a tapered component; and the distal portion 104c may generally comprise an externally-threaded distal component and terminate into a tip portion. Medial portion 104b and distal portion 104c may collectively be referred to as a “stud.” The ball-head 104a of ball-head tapered ball joint pin 104 may be configured to seat within the recess 108 of ball joint assembly 102 when the lower ball joint assembly 100 is in an assembled configuration (explained in more detail below). When seated therein, however, ball-head 104a should be capable of rotational movement within recess 108.

An outer surface, or wear surface, of ball-head 104a may include a plurality of grooves 105 radially extending downwardly, from a top portion 107 of ball head 104a toward the medial portion 104b of the ball joint pin 104, at least partially around a circumference of the ball-head 104a. In one embodiment, the plurality of grooves 105 may extend approximately half way around the circumference of the ball-head 104a. As shown, the plurality of grooves may be radially and circumferentially spaced on the ball head 104a in a cross-hatch pattern, however, this is by example only. Many other possible configurations and patterns are contemplated, including but not limited to the grooves extending downwardly in an “S” pattern or shape. In accordance with one embodiment, the plurality of grooves 105 may be used to provide a passageway for grease or other lubricates over the wear surface of the ball head 104a to reduce the friction between the ball head 104a and the recess 108 of the ball joint housing 102 and reducing wear. The ball joint housing may include a zerk fitting for feeding lubricants into the assembly.

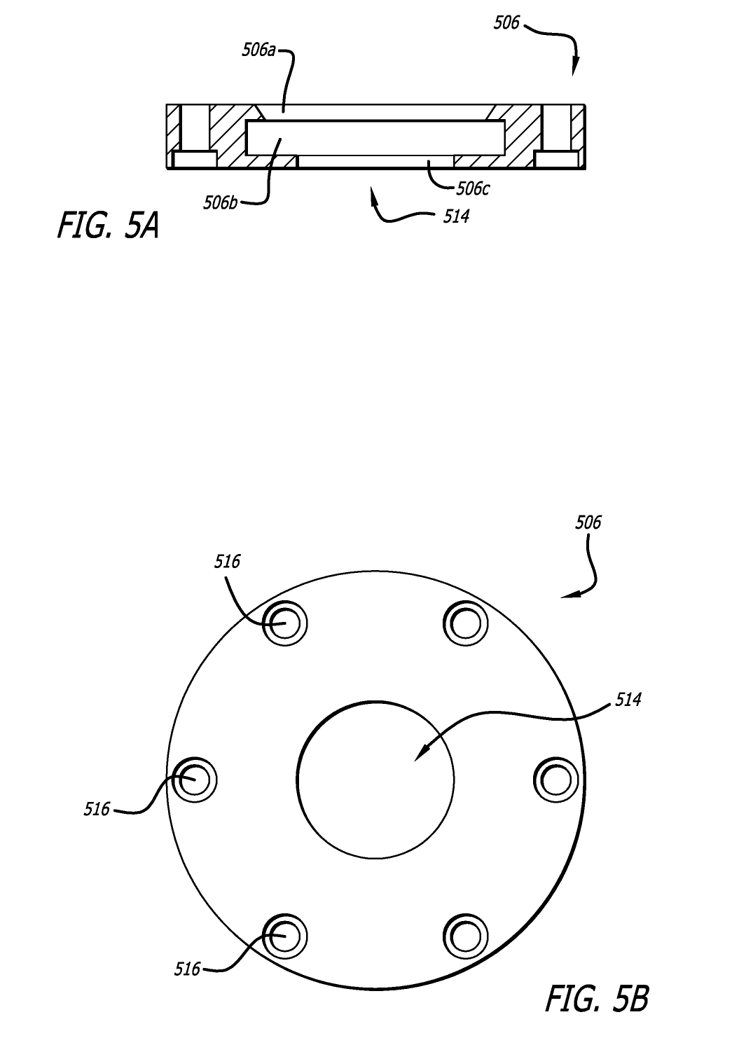

Continuing to refer to FIG. 1, securing ring 106 includes a securing ring opening 114 throughout a center thereof. In one embodiment, securing ring 106 comprises a securing ring upper flange, a securing ring medial portion and securing ring lower flange (not shown, see FIG. 5A). Similar to the plurality of openings 110 of ball joint housing 102, a plurality of openings 116 may be symmetrically spaced about the securing ring 106. Generally, the plurality of openings 116 extend completely through securing ring 106 and are configured to threadedly receive the plurality of fasteners 112. The securing ring 106 is adapted to reversibly couple to the distal end of the ball joint housing 102 when the ball-head 104a is seated within the ball joint housing 102 (see FIG. 2). When coupled thereto, the plurality of openings 116 of securing ring 106 correspond to the plurality of openings 110 of the lower flange 102d of the ball joint housing 102. That is, the plurality of openings 110, 116 may be aligned relative to one another.

FIG. 2 illustrates a side view of the lower ball joint assembly of FIG. 1 in an assembled configuration. As shown, the securing ring 106 is coupled to the ball joint housing 102 with a portion of the ball-head tapered ball joint pin 104 protruding downwardly therefrom. Also shown in FIG. 2 is a partial view of a connector 118 (explained in more detail below). The lower ball joint assembly 100 may be partially, substantially or completely constructed from high-strength alloys including carbon steels, chromium steel, molybdenum steels, vanadium steels, micro-alloyed steels, alloy steels including low- and high-alloy steels, stainless steel, super alloys, titanium alloys, aluminum alloys, copper alloys including copper-beryllium alloys, or various tool and die steels and other alloys. In one embodiment, the lower ball joint assembly 100 may be constructed of 4130 (chromium-molybdenum (chromoly)) or 9310 (nickel-chromium-molybdenum) steel.

Examples of AISI designations for these alloys include, but are not limited to 10xx, 11xx, 12xx, 13xx, 15xx, 23xx, 25xx, 29xx, 31xx, 32xx, 33xx, 34xx, 40xx, 41xx, 43xx, 44xx, 46xx, 47xx, 48xx, 50xx, 51xx, 52xx, 61xx, 72xx, 81xx, 86xx, 87xx, 88xx, 92xx, 93xx, 94xx, 97xx, and 98xx and many modifications based on these alloys. As used herein “xx” designates specific composition, i.e. grade, of the alloy. Almost all alloys also have other designations in addition to AISI designation and sometime specific alloys have names. Although high-strength low-alloy steels are preferred materials for the upper ball joint according to embodiments of the invention other alloys or their alloy hybrids may be suitable. In one embodiment, the lower ball joint assembly 200 may also be carbonized and/or heat treated to achieve hardness of between (40) and one-hundred (100) Rockwell Hardness in C-scale (HRC) and tensile strengths of over 300 kilo pound per square inch (kpsi).

The “Rockwell scale” is a hardness scale based on the indentation hardness of a material. A Rockwell test determines the hardness by measuring the depth of penetration of an indenter under specific loads from 60 kilograms force (kgf) to 150 kgf and specific indenter configurations corresponding to letters A through G. Rockwell hardness C corresponds to a load of 150 kgf and 120 degree diamond cone indenter. The numerical expression of hardness in a Rockwell scale represents the load in kilograms force. In one embodiment, the lower ball joint assembly 100 has a hardness of at least fifty-six (56) HRC, in one embodiment, sixty (60) HRC. The ultimate strength of a material is a function of its composition and the heat treatment process to which is it subjected.

Ultimate strength is also a measure of the ability of the material to withstand an applied stress, usually in tension, before fracture. One pound force applied to one inch square results in one psi stress. One thousand pound force applied to one inch square produces one kpsi (also known as ksi), stress. In one embodiment, the ultimate strength of the lower ball joint assembly 100 is about 175 ksi.

FIG. 3 illustrates a side cross-sectional view of a ball joint housing of a lower ball joint assembly according to an embodiment of the invention. As shown, the ball joint housing 302 approximates a cylindrical housing; however, other suitable configurations are within the scope of the invention. From the proximal end to the distal end, the ball joint housing 302 includes a ball joint housing upper flange 302a with a diameter of about 1.7811±0.001 inches, a first portion 302b with a diameter of about 1.715±0.001 inches, a second portion 302c with a diameter of about 1.795±0.001 inches and a ball joint housing lower flange 302d with a diameter of about 2.4±0.001 inches. A recess 308 may have a diameter of about 1.504±0.001 inches and a height of about 1.058±0.001 inches. The overall height of the ball joint housing 302 may be about 1.555 inches; however one of ordinary skill in the art will appreciate that the measurements specified will vary depending on the vehicle in which the assembly is installed.

As described above, the recess 308 may comprise a hemispherical top portion 310, a generally circular base portion 312 and a channel 314 located there between approximating a dome configuration. The channel 314 may be used to contain grease or other lubricant, from the plurality of grooves as described above, within the ball joint housing 302 and creating a reservoir of the grease inside the ball joint housing 302.

Also shown in FIG. 3 is a connector 318 in the uppermost portion of the ball joint housing 302. The connector 318 is fitted within a threaded opening within the ball joint housing 302 and is situated in an angled position as known by one of ordinary skill in the art. Connector 318 may connect to the steering knuckle as known by one of ordinary skill in the art.

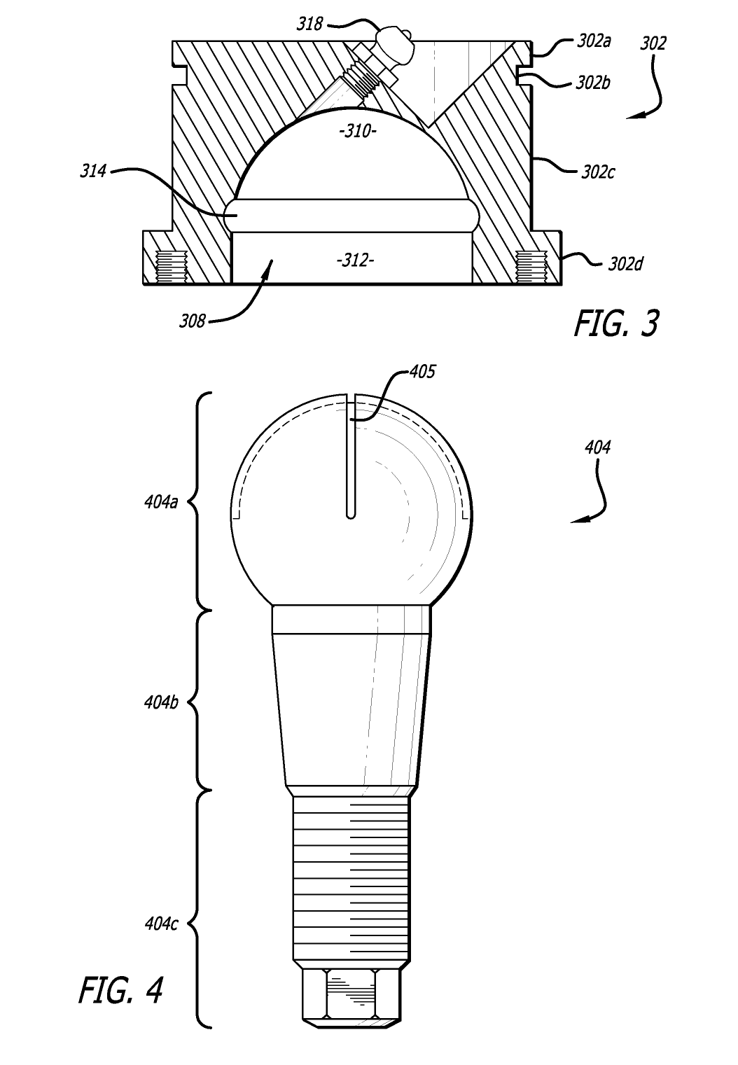

FIG. 4 illustrates a side view of a ball-head tapered ball joint pin of a lower ball joint assembly according to an embodiment of the invention. As shown, the ball-head tapered ball joint pin 404 includes a proximal portion 404a, a medial portion 404b, and a distal portion 404c. The proximal portion 404a is a ball-head with a circumference of about 1.500±0.001 inches and a height of about 1.310±0.001 inches. The medial portion 404b, integrally connected between the proximal portion 404a and the distal portion 404c, may begin as a cylindrical component with a diameter of about 1.0±0.001 inches and terminate into a tapered component with a diameter of about 0.860±0.001 inches. The distal portion 404c may begin as an externally-threaded distal component and terminate into a tip portion with a total height of about 1.380 inches. In one embodiment, the tip portion is a 7/16 inch hex nut.

An outer surface, or wear surface, of ball-head 404a may include a plurality grooves 405 extending downwardly, from a top portion 407 of ball head 404a toward the medial portion 404b, at least partially around a circumference of the ball-head 404a. In one embodiment, the plurality of grooves 405 may extend approximately half way around the circumference of the ball-head 404a. As shown, the plurality of grooves 405 may be radially and circumferentially spaced on the ball head 404a in a cross-hatch pattern, however, this is by example only. Many other possible configurations and patterns are contemplated, including but not limited to the grooves extending downwardly in an “S” pattern or shape. In accordance with one embodiment, the plurality of grooves 405 may be used to provide a passageway for grease or other lubricates over the wear surface of the ball head 404a to reduce the friction between the ball head 404a and the recess 308 of the ball joint housing 302 and reducing wear.

FIGS. 5A-5B illustrate a side cross-sectional view and a top view of a securing ring of a lower ball joint assembly according to an embodiment of the invention. As shown, from a proximal end to a distal end, securing ring 506 comprises a securing ring upper flange 506a, a securing ring medial portion 506b and securing ring lower flange 506c. A securing ring opening 514 extends through the center of securing ring 506. In one embodiment, the securing ring upper flange 506a has a tapered inner sidewall. Generally, the securing ring middle portion 506b has diameter greater than both the securing ring upper flange 506a and the securing ring lower flange 506c. In one embodiment, the securing ring middle portion 506b may be an O-ring for retaining the grease or other lubricant and preventing the grease or other lubricant from leaking outside the securing ring 506.

In one embodiment, securing ring upper flange 506a has at least one diameter of about 1.365±0.1 inches, securing ring medial portion 506b has a diameter of about 1.505±0.001 inches and securing ring lower flange 502c with a diameter of about 1.160±0.001 inches. It should be appreciated that, since securing ring upper flange 506a has a tapered inner sidewall, securing ring upper flange 506a has multiple diameters.

Referring to FIG. 5B, a plurality of openings 516 are shown symmetrically spaced about the securing ring 506. As previously described, the plurality of openings 516 of securing ring 506 correspond to the plurality of openings of the lower flange of the ball joint housing (not shown, see FIG. 3). When the securing ring 506 is coupled to the ball joint housing, a plurality of fasteners reversibly secure the components together.

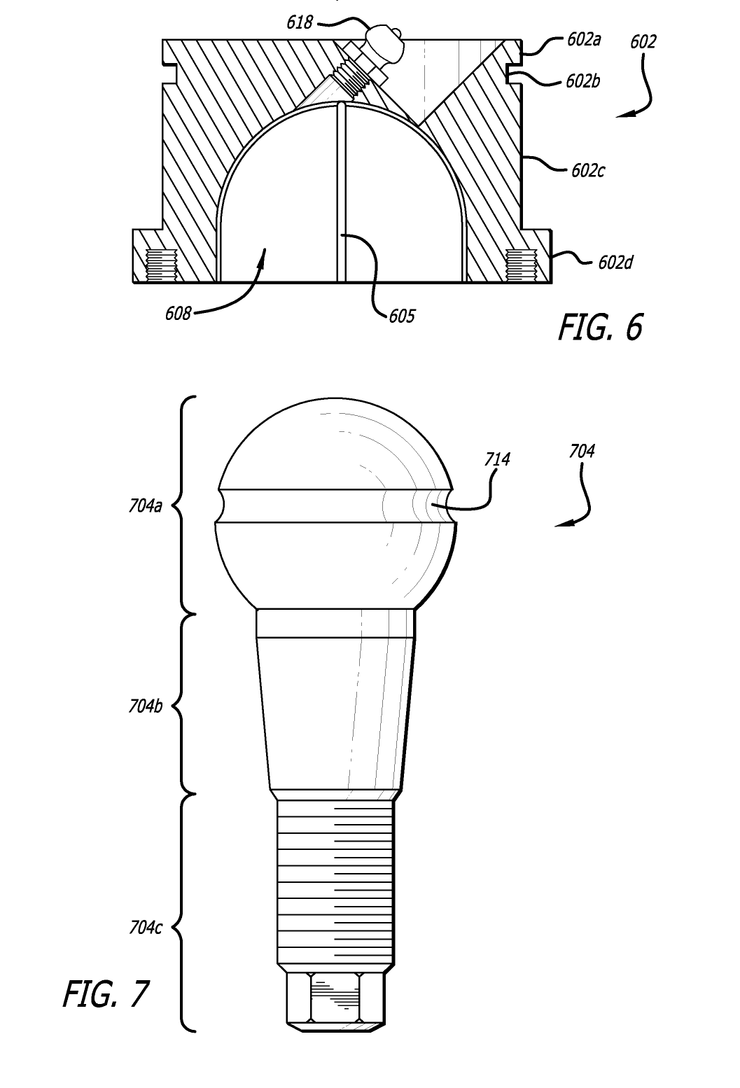

FIG. 6 illustrates a side cross-sectional view of a ball joint housing of a lower ball joint assembly according to a second embodiment of the invention. As shown, the ball joint housing 602 approximates a cylindrical housing; however, other suitable configurations are within the scope of the invention. From the proximal end to the distal end, the ball joint housing 602 includes a ball joint housing upper flange 602a with a diameter of about 1.7811±0.001 inches, a first portion 602b with a diameter of about 1.715±0.001 inches, a second portion 602c with a diameter of about 1.795±0.001 inches and a ball joint housing lower flange 602d with a diameter of about 2.4±0.001 inches. A recess 608 may have a diameter of about 1.504±0.001 inches and a height of about 1.058±0.001 inches. The overall height of the ball joint housing 602 may be about 1.555 inches; however one of ordinary skill in the art will appreciate that the measurements specified will vary depending on the vehicle in which the assembly is installed.

The recess 608 may comprise a hemispherical top portion integrally connected to a generally circular base portion forming a dome shaped configuration. A plurality of grooves 605 may be radially and circumferentially spaced within the recess for dispersing grease or other lubricant over the wear surface of the ball head 704a to reduce the friction between the ball head 704a and the recess 608 of the ball joint housing 702 and reducing wear. In one embodiment, the plurality of grooves 605 may extend downwardly from the hemispherical top portion toward the base portion. Although the plurality of grooves 605 is shown in a cross-hatch pattern, this is by way of example only. Many other possible configurations and patterns are contemplated, including but not limited to the grooves extending downwardly in an “S” pattern or shape.

Also shown in FIG. 6 is a connector 618 in the uppermost portion of the ball joint housing 602. The connector 618 is fitted within a threaded opening within the ball joint housing 602 and is situated in an angled position as known by one of ordinary skill in the art. Connector 618 connects to the steering knuckle as known by one of ordinary skill in the art.

FIG. 7 illustrates a side view of a ball-head tapered ball joint pin of a lower ball joint assembly according to a second embodiment of the invention. As shown, the ball-head tapered ball joint pin 704 includes a proximal portion 704a, a medial portion 704b, and a distal portion 704c. The proximal portion 704a is a ball-head with a circumference of about 1.500±0.001 inches and a height of about 1.310±0.001 inches. The medial portion 704b, integrally connected between the proximal portion 704a and the distal portion 704c, may begin as a cylindrical component with a diameter of about 1.0±0.001 inches and terminate into a tapered component with a diameter of about 0.860±0.001 inches. The distal portion 704c may begin as an externally-threaded distal component and terminate into a tip portion with a total height of about 1.380 inches. In one embodiment, the tip portion is a 7/16 inch hex nut.

An outer surface of ball-head 704a may include a channel 714 extending around the circumference. The channel 714 may be used to contain the grease or other lubricant within the ball joint housing and creating a reservoir of the grease inside the ball joint housing.

According to embodiments of the invention, the lower ball joint assembly as previously described may be manufactured as follows. A high-strength low-alloy steel may be machined to create one or more components of the lower ball joint assembly, i.e., a ball joint housing, a ball-head tapered ball joint pin and a securing ring. Then, the assembled components may be heat treated to achieve a hardness of between forty (40) and one-hundred (100) Rockwell. Then, a non-liquid lubricant (i.e., a “dry-lube”) may be applied to the assembled components to a specified thickness. The dry-lube may be applied in one or more applications or stages to one or more surfaces of the assembly. Examples of suitable dry-lubes include, but are not limited to, polytetrafluroethylene (PTFE), graphite, molybdenum disulfide and tungsten disulfide.

According to embodiments of the invention, the lower ball joint assembly as previously described was discovered to break-in after use and, therefore, increase performance. The manufacturing process as previously described was discovered to result in a substantially smooth inner surface of the assembly, which inner surface was discovered to contain a plurality of pores generally not visible by the eye. In one embodiment, the lubrication process partially, substantially or completely fills the pores of the surface of the assembly. After a period of time and consistent use (i.e., when the assembly is installed in vehicles as previously described), it was discovered that the surface(s) of the assembly burnished. Applicant discovered that, upon removing the pin from the assembly, the inner surfaces of the assembly exhibited a luster caused by burnishing through normal use of the assembly. The burnished surfaces were discovered by Applicant to result in reduced friction and smoothed-out rotation relative to non-burnished surfaces. This discovery was unexpected in view of the conventional expectation is that such assemblies decrease in performance after repeated use. Applicant discovered that the superior performance of the assemblies according to embodiments of the invention were partially or substantially due to the design and manufacture of the ball joint cup, i.e., the additional material and surface provided by the two-tiered ball joint cup; the heating process resulting in increased hardness (Rockwell); and the two-stage lubrication process.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A lower ball joint assembly, comprising:
a ball-head tapered ball joint pin having a proximal portion, a medial portion and a distal portion, the proximal portion comprising a ball-head having a plurality of grooves radially extending downwardly, from a top portion of the ball-head toward the medial portion of the ball joint pin, at least partially around a circumference of the ball-head;
a ball joint housing having a recess therein adapted to receive at least a portion of the ball-head of the ball-head tapered ball joint pin; and
a securing ring having a securing ring opening in the center thereof, the securing ring adapted to reversibly couple to a distal end of the ball joint housing.

2. The lower ball joint assembly of claim 1, wherein the recess of the ball joint housing comprises a hemispherical top portion, a generally circular base portion and a channel located there between approximating a dome configuration; and wherein the channel collects lubricant dispersed via the plurality of grooves creating a reservoir of the lubricant inside the housing.

3. The lower ball joint assembly of claim 1 wherein the medial and distal portions of the pin comprise a stud, the stud comprising a tapered portion followed by an externally-threaded portion, the externally-threaded portion terminating in a tip portion.

4. The lower ball joint assembly of claim 3 wherein the externally-threaded portion has a diameter (i) less than the smallest diameter of the tapered portion and (ii) greater than a diameter of the tip portion.

5. The lower ball joint assembly of claim 1 wherein, from a proximal end to the distal end, the securing ring comprises a securing ring upper flange, a securing ring medial portion and securing ring lower flange.

6. The lower ball joint assembly of claim 5 wherein the securing ring upper flange has a tapered inner sidewall.

7. The lower ball joint assembly of claim 6 wherein the securing ring upper flange has at least one inner diameter (i) less than an inner diameter of the securing ring medial portion and (ii) greater than an inner diameter of the securing ring lower flange.

8. The lower ball joint assembly of claim 1 wherein the securing ring includes a plurality of openings about a periphery thereof, the plurality of openings adapted to receive a plurality of fasteners.

9. The lower ball joint assembly of claim 8 wherein, from a proximal end to the distal end, the ball joint housing comprises an ball joint housing upper flange, a first portion, a second portion and a ball joint housing lower flange.

10. The lower ball assembly of claim 9 wherein the ball joint housing lower flange includes a plurality of openings corresponding to the plurality of openings on the securing ring.

11. The lower ball joint assembly of claim 10 wherein, in an assembled configuration, (i) the ball-head rests within the recess of the ball joint housing and (ii) a plurality of fasteners reversibly couple the securing ring to the lower flange of the ball joint housing thereby securing the ball-head within the recess of the ball joint housing.

12. The lower ball joint assembly of claim 7 wherein, in an assembled configuration, the ball-head of the pin is capable of rotational movement within the recess of the ball joint housing.

13. The lower ball joint assembly of claim 1, further comprising, a non-liquid lubricant applied to at least one inner surface of the assembly.

14. The lower ball joint assembly of claim 13 wherein the non-liquid lubricant is polytetrafluroethylene.

15. The lower ball joint assembly of claim 1 wherein the lower ball joint assembly is comprised of high-strength low-alloy steel and has a hardness greater than 56 Rockwell.

16. A process for manufacturing a lower ball joint assembly, comprising:
forming a ball-head tapered ball joint pin from high-strength low-alloy steel, the ball-head tapered ball joint pin having a proximal portion, a medial portion and a distal portion, the proximal portion comprising a ball-head having a plurality of grooves radially extending downwardly, from a top portion of the ball-head toward the medial portion of the ball joint pin, at least partially around a circumference of the ball-head;
forming a ball joint housing from high-strength low-alloy steel, the ball joint housing having a recess therein adapted to receive at least a portion of the ball-head of the ball-head tapered ball joint pin; and
forming a securing ring from high-strength low-alloy steel, the securing ring having a securing ring opening in the center thereof, the securing ring adapted to reversibly couple to a distal end of the ball joint housing wherein the joint assembly has a hardness greater than 56 Rockwell.

17. The process of claim 16, wherein the recess of the ball joint housing comprises a hemispherical top portion, a generally circular base portion and a channel located there between approximating a dome configuration; and wherein the channel collects lubricant dispersed via the plurality of grooves creating a reservoir the lubricant inside the ball joint housing.

18. The process of claim 16, further comprising, applying a non-liquid lubricant to the assembly.

19. The process of claim 18, further comprising, applying a heat treatment to the assembly to achieve the hardness greater than 56 Rockwell.

20. The process of claim 16, further comprising:
inserting the ball-head into the ball joint housing such that ball-head is seated within the recess of the ball joint housing; and
coupling the securing ring to the ball joint housing thereby securing the ball-head within the recess of the ball joint housing.
